(19) United States
(12) Patent Application Publication
(10) Pub. No.: US 2021/0082187 A1
(43) Pub. Date: Mar. 18, 2021

(54) HAPTIC SIMULATION OF MOTION IN VIRTUAL REALITY

(71) Applicant: Microsoft Technology Licensing, LLC, Redmond, WA (US)

(72) Inventor: Anatolie GAVRILIUC, Kirkland, WA (US)

(73) Assignee: Microsoft Technology Licensing, LLC, Redmond, WA (US)

(21) Appl. No.: 16/572,385

(22) Filed: Sep. 16, 2019

(51) Int. Cl. G06T 19/00; G02B 27/01; G06F 3/01; G02B 27/00; A63F 13/215

(52) U.S. Cl. CPC G06T 19/006; G02B 27/017; G06F 3/012; A63F 2300/8082; G02B 27/0093; A63F 13/215; G06F 3/013

(57) ABSTRACT

A virtual reality device includes a near-eye display; a logic machine; and a storage machine holding instructions executable by the logic machine to: via the near-eye display, present virtual image frames depicting a virtual environment. The virtual image frames are dynamically updated to simulate movement of a user of the virtual reality device through the virtual environment. Movement-simulating haptics are provided to a vestibular system of the user via one or more vestibular haptic devices, based on the simulated movement of the user through the virtual environment.

### BACKGROUND

Virtual reality devices are configured to present virtual images depicting a virtual environment that replaces a user's view of their own surrounding real-world environment. Users may navigate the virtual environment with or without physically moving in the real world. Use of virtual reality devices can cause motion sickness, or other unpleasant symptoms, for some users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A virtual reality device includes a near-eye display; a logic machine; and a storage machine holding instructions executable by the logic machine to: via the near-eye display, present virtual image frames depicting a virtual environment. The virtual image frames are dynamically updated to simulate movement of a user of the virtual reality device through the virtual environment. Movement-simulating haptics are provided to a vestibular system of the user via one or more vestibular haptic devices, based on the simulated movement of the user through the virtual environment.

### BRIEF DESCRIPTION OF THE DRAWINGS

FIGS. 1A, 1B, and 1C schematically depict a virtual reality device providing a virtual reality experience to a user.

FIG. 2 illustrates an example method for reducing motion sickness for a virtual reality device.

FIGS. 3, 4, and 5 schematically depict different example virtual reality devices having different vestibular haptic devices.

FIGS. 6 and 7 show plots that illustrate providing motion simulating haptics based on simulated motion of a user through a virtual environment.

FIG. 8 schematically depicts another example virtual reality device including multiple haptic devices.

FIG. 9 shows plots that illustrate providing movement-unrelated haptics regardless of simulated motion of a user through a virtual environment.

FIG. 10 shows plots that illustrate reducing motion simulating haptics upon detecting physical movement of a user through a real-world environment.

FIG. 11A schematically shows an example virtual reality computing system.

FIG. 11B schematically shows an example haptic device of the virtual reality computing system of FIG. 11A.

FIG. 12 schematically shows an example computing system.

### DETAILED DESCRIPTION

As discussed above, use of virtual reality devices can induce motion sickness and/or other unpleasant symptoms in some users. This is thought to arise when the brain senses a disconnect between signals provided by the visual system and by the vestibular system, which is located in the inner ear and helps to maintain balance and equilibrium. For instance, a user of a virtual reality device who moves through a virtual environment without also physically moving through their real-world environment may experience motion sickness. This may occur when their visual system perceives that they are moving (e.g., simulated movement through the virtual environment), while their vestibular system does not experience the shocks and jolts associated with actual movement, for instance caused by footfalls or vehicle vibrations.

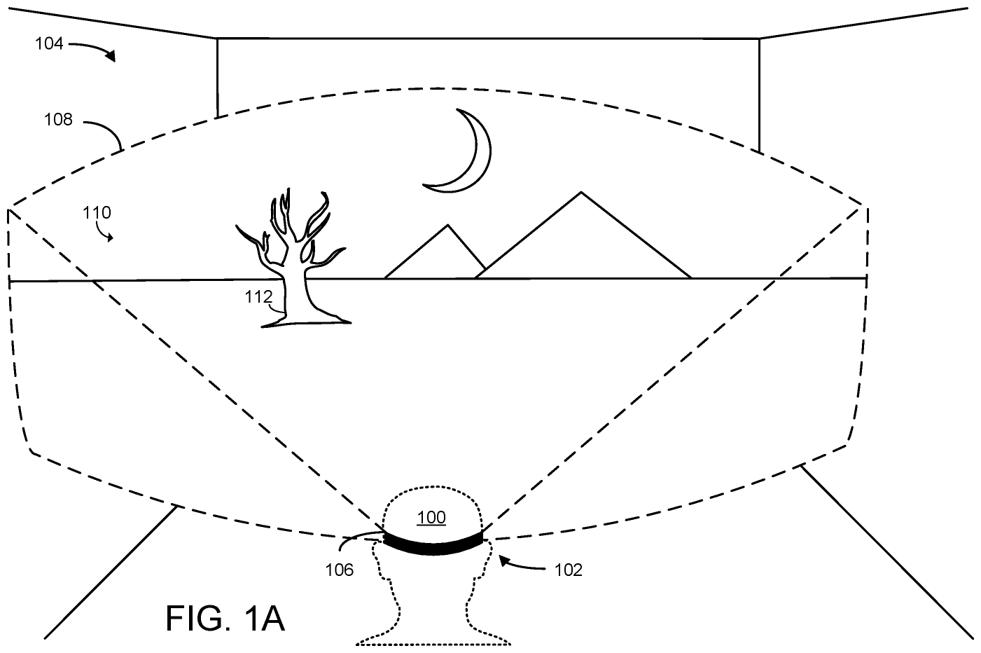

For instance, FIG. 1 schematically shows a user 100 using a virtual reality device 102 in a real-world environment 104. Via a near-eye display 106 of the virtual reality device, user 100 has a field-of-view 108 of a virtual environment 110. The virtual environment is presented as a series of virtual image frames presented to the eyes of the user via the near-eye display, such that the user's view of their surrounding real-world environment is partially, or entirely, replaced by virtual content. Virtual environment 110 includes a virtual tree 112, which is a computer-generated representation of a tree that does not exist in the real-world, as well as a virtual landscape that differs from the user's real-world surroundings.

The present disclosure primarily focuses on virtual reality scenarios in which the virtual reality device provides virtual imagery that mostly or entirely replaces the user's view of their own real-world environment. It will be understood, however, that providing movement-simulating haptics as discussed herein may be beneficial in augmented/mixed reality settings in which the real-world remains at least partially visible to the user—e.g., via a partially transparent display, live video feed, or other approach. Thus, the term “virtual environment” will be used to refer both to fully virtual experiences, as well as augmented/mixed experiences, and all such experiences may be provided by “virtual reality devices.”

Turning now to FIG. 1B, user 100 is still using virtual reality device 102 to view virtual environment 110. However, the virtual reality device has updated the displayed virtual image frames as the user moves towards tree 112 in the virtual environment. In other words, the virtual reality device has simulated movement of the user through the virtual environment, even though the user's physical position in the real world has not changed at all. Thus, the user may begin to experience motion sickness, and/or other undesirable symptoms, due to a disconnect between the presented virtual imagery conveying motion without corresponding stimulation of the user's vestibular system. In this example, the simulated movement of the user is a change in the user's position relative to the virtual environment. However, motion sickness may also arise during simulated changes in the user's orientation—e.g., a change in the user's pitch, roll, or yaw. Thus, a “simulated movement” of the user may involve any change in a virtual six degree-of-freedom (6DOF) pose of the user relative to the virtual environment.

Various techniques may be employed to mitigate these problems, although some techniques have associated drawbacks. For instance, a device could require users to move through a virtual environment by teleporting from one location to another, without experiencing smooth or continuous simulated movement along the way. While this could alleviate motion sickness, it also would disrupt the user's immersion in the virtual experience. As other examples, a device or application could reduce the user's field-of-view (FOV) of the virtual environment while moving, or require the user to perform some physical, real-world movement to move through the virtual environment. Such movements could include, as examples, physically walking through the real-world, walking in place, performing a swimming motion with their arms, etc. Once again, these approaches could compromise the user's immersion in the virtual environment, as well as physically tire the user and interfere with any local space constraints (e.g., small room, nearby furniture) the user may have.

Accordingly, the present disclosure describes improved techniques for reducing motion sickness while using virtual reality devices. Specifically, based on simulated movement of the user through a virtual environment, the virtual reality device may provide movement-simulating haptics to a vestibular system of the user via one or more vestibular haptic devices. As one example, a vestibular haptic device may be positioned near (e.g., behind) an ear of a user, such that vibration generated by the vestibular haptic device stimulates the vestibular system of the user during simulated movement of the user through a virtual environment. In other examples, vestibular haptic devices may be positioned in other suitable locations relative to the user's body. Motion sickness and/or other unpleasant symptoms may be at least partially mitigated during use of virtual reality devices by alleviating the brain's perception of a disconnect between signals provided by the visual and vestibular systems.

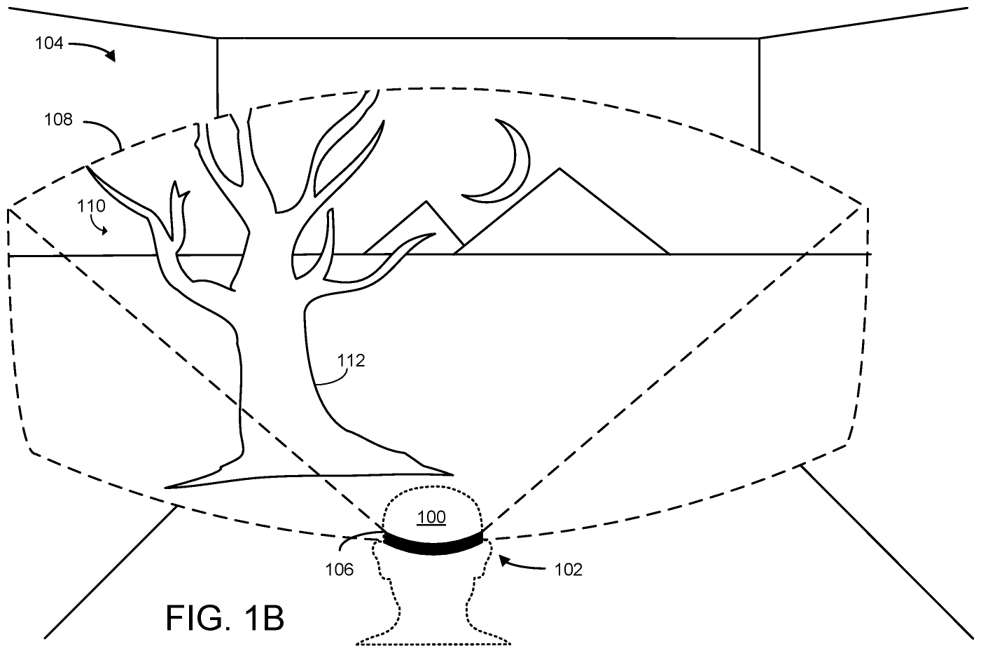

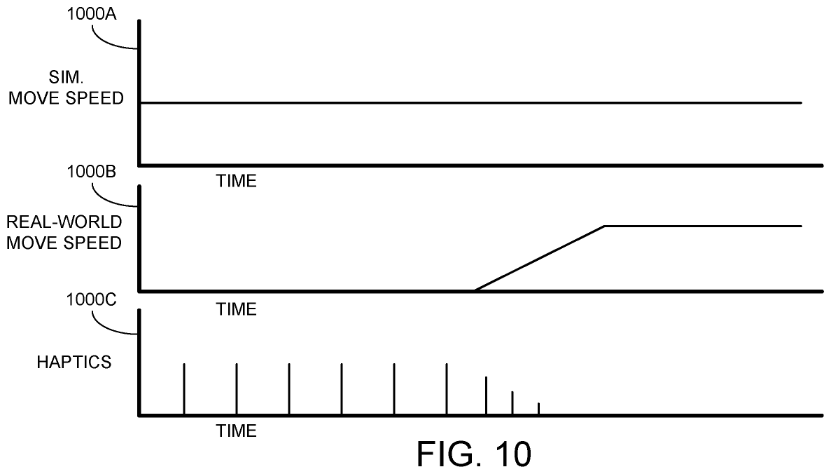

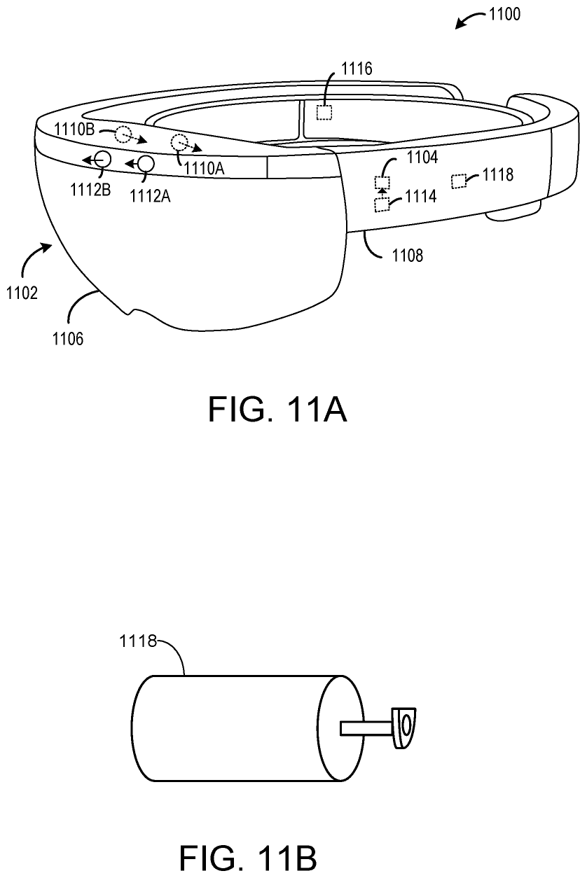

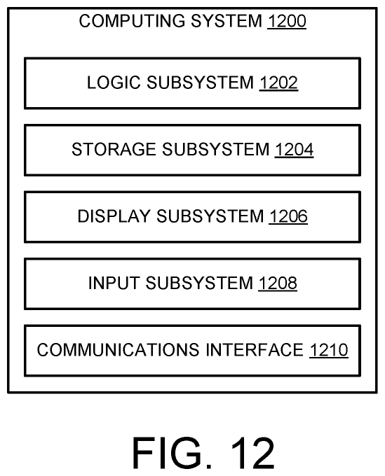

FIG. 2 illustrates an example method 200 for reducing motion sickness for a virtual reality device. The virtual reality device used to implement method 200 may have any hardware configuration and form factor suitable for displaying virtual imagery to a user. The virtual reality device may in some cases be a head-mounted display device, such as the virtual reality computing system 1100 described below with respect to FIG. 11. Compute hardware used to render virtual image frames may be integrated into a same housing as a display used to present the virtual image frames, and/or the compute hardware may be peripheral to the display (e.g., in a offboard rendering computer). In some examples, computing functions provided by the virtual reality device may be implemented by computing system 1200 described below with respect to FIG. 12.

At 202, method 200 includes presenting virtual image frames depicting a virtual environment. At 204, method 200 includes dynamically updating the virtual image frames to simulate movement of a user through the virtual environment. This is illustrated in FIGS. 1A and 1B. As discussed above, between FIGS. 1A and 1B, the virtual reality device updates the virtual image frames to simulate movement (e.g., walking, running, flying, driving, and/or riding) of the user through the virtual environment. This may be done independently of any movement of the user through the real-world environment.

The virtual environment provided by the virtual reality device may have any suitable appearance and purpose. As one example, the virtual environment may be part of a video game, in which case the virtual image frames depicting the virtual environment may be rendered by a video game application running on the virtual reality device, or another suitable device. As other examples, the virtual environment may be provided as part of a telepresence application, non-interactive experience (e.g., movie, animation), or editing/creation tool. Furthermore, the virtual reality device may simulate movement of the user through the virtual environment at any suitable time and for any suitable reason. For example, simulated movement may occur in response to user actuation of an input device (e.g., joystick, button), vocal command, gesture command, real-world movement. The simulated movement may additionally or alternatively occur independently of user input—e.g., as part of a scripted event in a video game.

Returning to FIG. 2, at 206, method 200 includes providing movement-simulating haptics to a vestibular system of the user via one or more haptic devices of the virtual reality device, the movement-simulating haptics provided based on the simulated movement of the user through the virtual environment. As will be described in more detail below, a vestibular haptic device may have any suitable form factor and stimulate the vestibular system of a user in any suitable way. For instance, a haptic device may include an eccentric rotating mass (ERM) actuator, including an unbalanced weight attached to a motor shaft. As an alternative, a haptic device may include a linear resonant actuator (LRA) that uses a magnetic voice coil to reciprocally displace a mass, thereby causing vibrations. In some examples, haptic devices may stimulate the vestibular system of a user via bone conduction. In other words, the haptic devices may vibrate with a frequency and intensity that causes the vibrations to propagate through a user's skull bones and stimulate the vestibular system in the inner ear. In general, a haptic device will translate electrical energy into vibrational energy and may accomplish this in any suitable way.

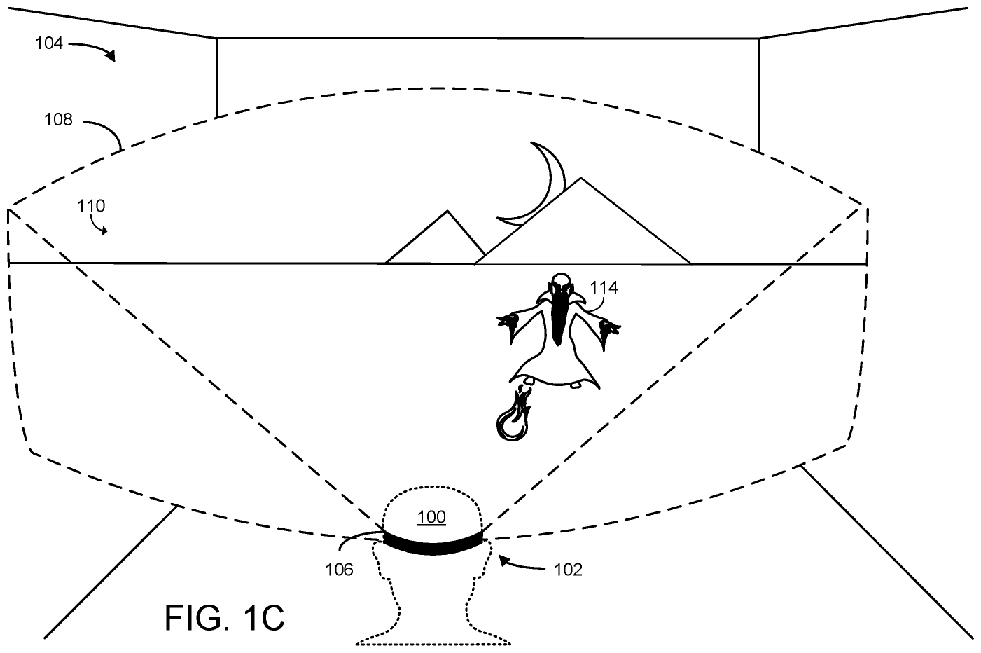

FIG. 3 schematically shows a user 300 with an example virtual reality device 302, including a near-eye display 304. In this example, the virtual reality device is a head-mounted display device and includes a vestibular haptic device 308 integrated into a frame 306 of the head-mounted display device. Specifically, the vestibular haptic device is integrated into a temple support of the head-mounted display device. In this example, the vestibular haptic device is positioned behind an ear of the user to stimulate the user's vestibular system located in the inner ear. Though not shown in FIG. 3, the virtual reality device may additionally include a second vestibular haptic device integrated into a second temple support and positioned behind the other ear of the user.

In FIG. 3, the vestibular haptic device is integrated into the same housing as the virtual reality device, although this need not be the case. Rather, in some examples, one or more vestibular haptic devices may be physically separate from, but communicatively coupled with, the virtual reality device. This is schematically shown in FIG. 4, which shows another user 400 with a virtual reality device 402 having a near-eye display 404. FIG. 4 also shows another example vestibular haptic device 406, again positioned behind an ear of the user. Unlike FIG. 3, however, vestibular haptic device 406 is physically separate from, but communicatively coupled with, the virtual reality device. The virtual reality device and vestibular haptic device may communicate in any suitable manner, including over a wired connection or a suitable wireless protocol (e.g., Bluetooth, Wi-Fi, near-field communication). In cases where the virtual reality device includes a near-eye display that is separate from the computer hardware used to render the virtual image frames (e.g., an offboard rendering computer), the vestibular haptic devices may be connected to either or both of the near-eye display and rendering computer, or physically separate from both the near-eye display and rendering computer.

As noted above, the vestibular system is located in the inner ear. It is therefore generally beneficial for the one or more vestibular haptic devices of the virtual reality device to be positioned in close proximity to the ear, as is shown in FIGS. 3 and 4. It will be understood, however, that vestibular haptic devices may have any suitable position with respect to the user's body, provided the vestibular haptic devices are still capable of stimulating the vestibular system.

For instance, a vestibular haptic device of a virtual reality device may contact a face of the user—e.g., touching the user's forehead, cheekbone, nose, jaw, or other anatomical feature. This is schematically illustrated in FIG. 5, which shows another example user 500 with a virtual reality device 502 having a near-eye display 504. In this example, however, the virtual reality device includes two vestibular haptic devices 506 that contact the face of the user rather than being positioned behind the user's ears.

The virtual reality devices shown in FIGS. 3, 4, and 5 are presented as nonlimiting examples. It will be understood that a virtual reality device as described herein may have any suitable hardware arrangement and form factor. Furthermore, a virtual reality device may have any number of haptic devices, including haptic devices not configured to stimulate the vestibular system of a user, as will be discussed in more detail below.

Regardless of the number and arrangement of vestibular haptic devices present, such vestibular haptic devices may provide movement-simulating haptics according to a variety of different control schemes, examples of which are described below. “Movement-simulating” haptics include any haptics that coincide with simulated motion of a user through a virtual environment and stimulate a user's vestibular system. Such haptics may use any suitable vibration frequency and intensity, and last for any suitable duration. Due to the proximity of the vestibular system to the eardrum, it may in some cases be beneficial for the movement-simulating haptics to use a vibration frequency, intensity, and duration that is inaudible to the user. In other words, the one or more vestibular haptic devices may vibrate with a frequency, intensity, and/or duration that stimulates the user's vestibular system without also stimulating the user's eardrum with enough intensity to cause the user to perceive the haptics as sound. Similarly, in cases where the vestibular haptic devices come into direct contact with the user's skin, a vibration frequency, intensity, and/or duration may be used that reduces the potentially irritating or annoying feeling of rumbling or buzzing that may be associated with use of vestibular haptic devices.

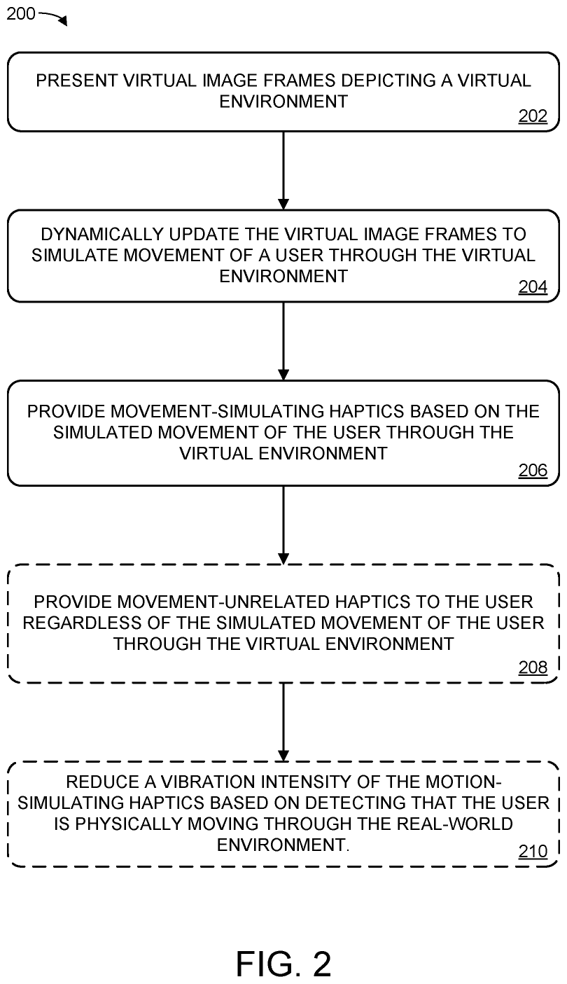

Movement-simulating haptics may be provided intermittently or continuously. FIG. 6 shows two different plots 600A and 600B, corresponding respectively to the simulated movement speed of a user through a virtual environment over time, and intensity of haptics provided by one or more haptic devices. Notably, in this example, the movement-simulating haptics are provided as a series of separate pulses. Such pulses may be separated by any suitable interval of time, and this interval need not be constant. For instance, in FIG. 6, the length of time between sequential pulses is inversely proportional to the current simulated movement speed of the user through the virtual environment. In other words, as the simulated movement speed of the user increases, the length of time between sequential movement-simulating haptics pulses decreases. In some cases, the haptics pulses may be synchronized to simulated footfalls of the user in the virtual environment—e.g., the virtual reality device may provide a movement-simulating haptic pulse each time a virtual user avatar takes a step. In such cases, left ear and right ear haptics optionally may be timed to coincide with corresponding left-foot and right-foot steps.

In some cases, one or both of the vibration intensity and frequency of the movement-simulating haptics may vary over time. This is also shown in FIG. 6, in which the intensity of the haptic pulses increases with simulated movement speed, as indicated by the relative heights of the vertical lines representing the haptic pulses on plot 600B. This is only one example, however, and movement-simulating haptics may vary over time in other suitable ways, including in implementations where the movement-simulating haptics are provided continuously.

This is illustrated in FIG. 7, which also shows two plots 700A and 700B, corresponding respectively to the simulated movement speed of a user through a virtual environment over time, and haptics provided by one or more haptic devices. Notably, in this example, the movement-simulating haptics are provided continuously, meaning over the period of time represented by plots 700A and 700B, the one or more vestibular haptic devices are always active. Regardless, the vibrational frequency and/or intensity of the movement-simulating haptics may still vary over time. This is also shown in plot 700B, in which the haptics include intermittent spikes of higher intensity, for instance corresponding to simulated footfalls of the user. It will be understood that continuous movement-simulating haptics need not persist indefinitely, and may be discontinued when the simulated movement of the user stops, the user exits the virtual environment, the device is powered off, etc.

The present disclosure has thus far focused on using haptics to stimulate a user's vestibular system, thereby simulating movement of the user through a virtual environment. It will be understood, however, that a virtual reality device may additionally provide other types of haptics. Accordingly, returning briefly to FIG. 2, at 208 method 200 optionally includes providing movement-unrelated haptics to the user regardless of the simulated movement of the user through the virtual environment.

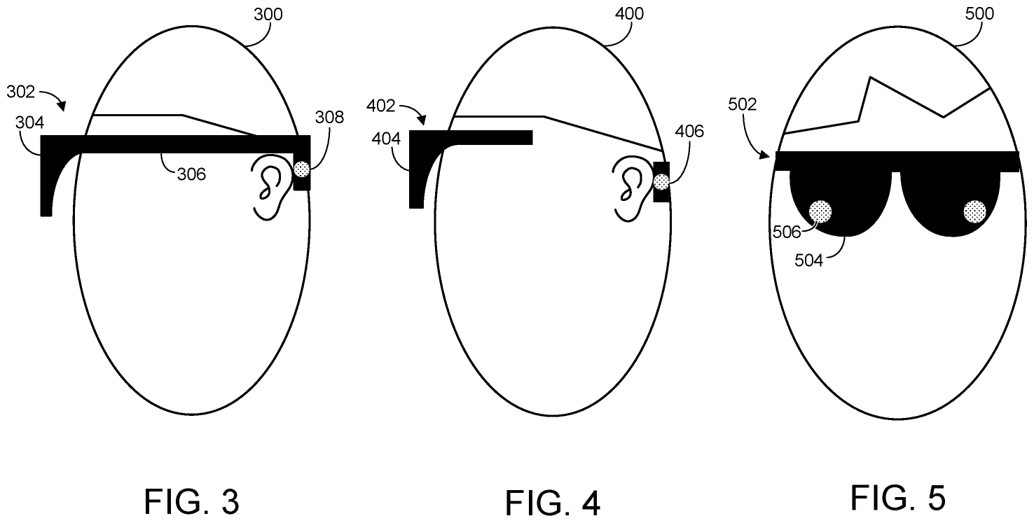

Such movement-unrelated haptics may in some cases be provided by one or more haptic devices different from the one or more vestibular haptic devices used to provide movement-simulating haptics. This is schematically shown in FIG. 8, which shows another example virtual reality device 800. Device 800 includes two vestibular haptic devices 802, configured to provide movement-simulating haptics as discussed above. Virtual reality device 800 also includes two haptic devices 804 other than the vestibular haptic devices. Haptic devices 804 may be configured to provide haptics that do not stimulate a vestibular system of the user, and/or may differ from the vestibular haptic devices in other ways (e.g., placement, rumble technology, vibration frequency, intensity).

Alternatively, the same haptic device used to provide movement-simulating haptics also may be used to provide haptics for other reasons. In such cases, the same haptic device may change haptic frequency, intensity, pattern or other parameters to provide different physical user responses.

As one example, the virtual reality device may provide haptics related to an interaction between the user and a virtual character or object in the virtual environment. Using the example of FIG. 1C, user 100 is still using virtual reality device 102 to view virtual environment 110. In the scenario depicted in FIG. 1C, user 100 is no longer moving, and thus virtual reality device 102 is not providing movement-simulating haptics to the user. However, the virtual reality device is rendering a hostile wizard character 114 that has cast a fireball spell at the user. When the virtual fireball reaches the simulated stationary position of the user in the virtual environment, the virtual reality device may provide haptics indicating that the user has been blasted by the fireball. Different haptic intensities, frequencies, patterns, and anatomical locations may be linked to different virtual effects (e.g., a fireball blast), and the different haptic parameters may provide different user responses. As such, a variety of different types of haptics, including movement-simulating haptics, may be used to create a more immersive virtual experience. Furthermore, the virtual reality device may provide haptics for reasons unrelated to the virtual environment (e.g., system notifications).

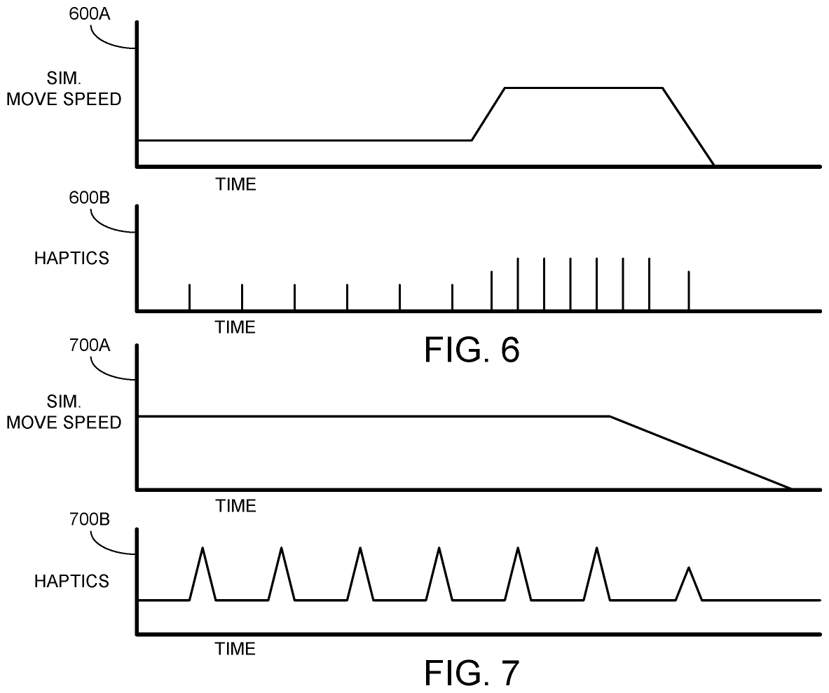

Movement-unrelated haptics are illustrated in FIG. 9, which shows three plots 900A, 900B, and 900C, respectively depicting a user's simulated movement speed through a virtual environment over time, occurrences of virtual interactions between the user and characters/objects in the virtual environment, and haptics provided by haptic devices. Notably, plot 900C depicts both movement-simulating haptics, shown in solid black lines, and movement-unrelated haptics, shown in dashed lines. Movement-unrelated haptics are provided each time a virtual interaction occurs, as shown in plot 900B. Meanwhile, the movement-simulating haptics are discontinued when the simulated movement of the user through the virtual environment ends. In some implementations, the movement-simulating haptics and the movement-unrelated haptics may use different haptic parameters (e.g., frequency, duration, intensity, pattern, anatomical placement).

Returning briefly to FIG. 2, at 210, method 200 optionally includes reducing a vibration intensity of the movement-simulating haptics based on detecting that the user is physically moving through the real-world environment. Providing movement-simulating haptics as discussed above will inherently consume electrical power of the virtual reality device, and it therefore may be beneficial to reduce or discontinue providing movement-simulating haptics when not needed. For instance, when the user is actually moving through the real-world, their footfalls (or other source of motion) may stimulate the user's vestibular system naturally, which can reduce or eliminate the risk of the user experiencing motion sickness. Real-world motion of the user may be detected in any suitable way, for instance via an inertial measurement unit (IMU) and/or camera of the virtual reality device, as will be discussed in more detail below with respect to FIG. 11.

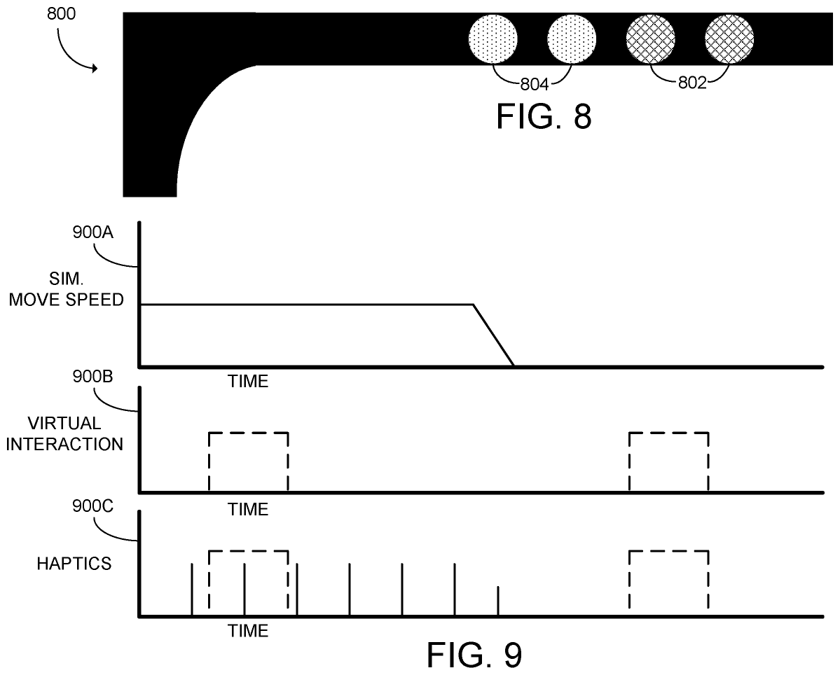

FIG. 10 depicts three plots 1000A, 1000B, and 1000C, respectively depicting a user's simulated movement speed through a virtual environment over time, a user's movement speed through a real-world environment, and haptics provided by the virtual reality device. As shown in plot 1000C, movement-simulating haptics are provided in regular separate pulses during simulated movement of the user through the virtual environment. However, as shown in plot 1000B, once the user begins physically moving through the real world, the movement-simulating haptics are discontinued, even as the simulated movement of the user through the virtual environment continues.

FIG. 11 shows aspects of an example virtual reality computing system 1100 including a near-eye display 1102. The virtual reality computing system 1100 is a non-limiting example of the virtual reality devices described herein and is usable for presenting virtual images to eyes of a user, such that they appear to partially or entirely replace the user's view of the real-world environment. Any or all of the virtual reality devices described herein may be implemented as computing system 1200 described below with respect to FIG. 12. It is to be understood that virtual reality devices as described herein also include mixed reality devices.

In some implementations, the virtual reality computing system 1100 may include a fully opaque near-eye display 1102 that provides a completely virtual experience in which the user is unable to see the real world environment.

In some implementations, the virtual reality computing system 1100 may include a fully opaque near-eye display 1102 configured to present a video feed of the real-world environment captured by a camera. In such examples, virtual imagery may be intermixed with the video feed to provide an augmented-reality experience.

In some implementations, the near-eye display 1102 is wholly or partially transparent from the perspective of the wearer, thereby giving the wearer a clear view of a surrounding physical space. In such a configuration, the near-eye display 1102 is configured to direct display light to the user's eye(s) so that the user will see virtual objects that are not actually present in the physical space. In other words, the near-eye display 1102 may direct display light to the user's eye(s) while light from the physical space passes through the near-eye display 1102 to the user's eye(s). As such, the user's eye(s) simultaneously receive light from the physical environment and display light and thus perceive a mixed reality experience.

Regardless of the type of experience that is provided, the virtual reality computing system 1100 may be configured to visually present virtual objects that appear body-locked and/or world-locked. A body-locked virtual object may appear to move along with a perspective of the user as a pose (e.g., a 6DOF pose) of the virtual reality computing system 1100 changes. As such, a body-locked virtual object may appear to occupy the same portion of the near-eye display 1102 and may appear to be at the same distance from the user, even as the user moves around the physical space. Alternatively, a world-locked virtual object may appear to remain at a fixed location in the physical space even as the pose of the virtual reality computing system 1100 changes.

The virtual reality computing system 1100 may take any other suitable form in which a transparent, semi-transparent, and/or non-transparent display augments or replaces a real-world view with virtual objects. While the illustrated virtual reality computing system 1100 is a wearable device that presents virtual images via a near-eye display, this is not required. For instance, an alternative virtual reality device may take the form of an opaque virtual reality vehicle simulator including a cylindrical display around a seat. In other words, implementations described herein may be used with any other suitable computing device, including but not limited to wearable computing devices, vehicle simulators, mobile computing devices, laptop computers, desktop computers, smart phones, tablet computers, heads-up-displays, etc.

Any suitable mechanism may be used to display images via the near-eye display 1102. For example, the near-eye display 1102 may include image-producing elements located within lenses 1106. As another example, the near-eye display 1102 may include a display device, such as a liquid crystal on silicon (LCOS) device or OLED microdisplay located within a frame 1108. In this example, the lenses 1106 may serve as, or otherwise include, a light guide for delivering light from the display device to the eyes of a wearer. Additionally, or alternatively, the near-eye display 1102 may present left-eye and right-eye virtual images via respective left-eye and right-eye displays.

The virtual reality computing system 1100 optionally includes an on-board computer 1104 configured to perform various operations related to receiving user input (e.g., gesture recognition, eye gaze detection), visual presentation of virtual images on the near-eye display 1102, providing movement-simulating and/or other haptics, and other operations described herein. Some to all of the computing functions described herein as being performed by an on-board computer may instead be performed by one or more off-board computers.

The virtual reality computing system 1100 may include various sensors and related systems to provide information to the on-board computer 1104. Such sensors may include, but are not limited to, one or more inward facing image sensors (e.g., cameras) 1110A and 1110B, one or more outward facing image sensors 1112A and 1112B, an inertial measurement unit (IMU) 1114, and one or more microphones 1116. The one or more inward facing image sensors 1110A, 1110B may be configured to acquire gaze tracking information from a wearer's eyes (e.g., sensor 1110A may acquire image data for one of the wearer's eye and sensor 1110B may acquire image data for the other of the wearer's eye).

The on-board computer 1104 may be configured to determine gaze directions of each of a wearer's eyes in any suitable manner based on the information received from the image sensors 1110A, 1110B. The one or more inward facing image sensors 1110A, 1110B, and the on-board computer 1104 may collectively represent a gaze detection machine configured to determine a wearer's gaze target on the near-eye display 1102. In other implementations, a different type of gaze detector/sensor may be employed to measure one or more gaze parameters of the user's eyes. Examples of gaze parameters measured by one or more gaze sensors that may be used by the on-board computer 1104 to determine an eye gaze sample may include an eye gaze direction, head orientation, eye gaze velocity, eye gaze acceleration, change in angle of eye gaze direction, and/or any other suitable tracking information. In some implementations, eye gaze tracking may be recorded independently for both eyes.

The one or more outward facing image sensors 1112A, 1112B may be configured to measure physical environment attributes of a physical space. In one example, image sensor 1112A may include a visible-light camera configured to collect a visible-light image of a physical space. In another example, the virtual reality computing system may include a stereoscopic pair of visible-light cameras. Further, the image sensor 1112B may include a depth camera configured to collect a depth image of a physical space. More particularly, in one example, the depth camera is an infrared time-of-flight depth camera. In another example, the depth camera is an infrared structured light depth camera.

Data from the outward facing image sensors 1112A, 1112B may be used by the on-board computer 1104 to detect movements, such as gesture-based inputs or other movements performed by a wearer or by a person or physical object in the physical space. In one example, data from the outward facing image sensors 1112A, 1112B may be used to detect a wearer input performed by the wearer of the virtual reality computing system 1100, such as a gesture. Data from the outward facing image sensors 1112A, 1112B may be used by the on-board computer 1104 to determine direction/location and orientation data (e.g., from imaging environmental features) that enables position/motion tracking of the virtual reality computing system 1100 in the real-world environment. In some implementations, data from the outward facing image sensors 1112A, 1112B may be used by the on-board computer 1104 to construct still images and/or video images of the surrounding environment from the perspective of the virtual reality computing system 1100. Additionally, or alternatively, data from the outward facing image sensors 1112A may be used by the on-board computer 1104 to infer movement of the user through the real-world environment. As discussed above, the movement-simulating haptics may be reduced or discontinued in response to real-world movement of the user.

The IMU 1114 may be configured to provide position and/or orientation data of the virtual reality computing system 1100 to the on-board computer 1104. In one implementation, the IMU 1114 may be configured as a three-axis or three-degree of freedom (3DOF) position sensor system. This example position sensor system may, for example, include three gyroscopes to indicate or measure a change in orientation of the virtual reality computing system 1100 within 3D space about three orthogonal axes (e.g., roll, pitch, and yaw).

In another example, the IMU 1114 may be configured as a six-axis or six-degree of freedom (6DOF) position sensor system. Such a configuration may include three accelerometers and three gyroscopes to indicate or measure a change in location of the virtual reality computing system 1100 along three orthogonal spatial axes (e.g., x, y, and z) and a change in device orientation about three orthogonal rotation axes (e.g., yaw, pitch, and roll). In some implementations, position and orientation data from the outward facing image sensors 1112A, 1112B and the IMU 1114 may be used in conjunction to determine a position and orientation (or 6DOF pose) of the virtual reality computing system 1100. As discussed above, upon determining that one or both of the position and orientation (or 6DOF pose) of the virtual reality computing system is changing in a manner consistent with real-world movement of the user, the movement-simulating haptics may be reduced or discontinued.

The virtual reality computing system 1100 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

The one or more microphones 1116 may be configured to measure sound in the physical space. Data from the one or more microphones 1116 may be used by the on-board computer 1104 to recognize voice commands provided by the wearer to control the virtual reality computing system 1100.

The on-board computer 1104 may include a logic machine and a storage machine, discussed in more detail below with respect to FIG. 12, in communication with the near-eye display 1102 and the various sensors of the virtual reality computing system 1100.

Virtual reality computing system 1100 may additionally, or alternatively, include one or more haptic devices 1118. The virtual reality device may include any number and variety of haptic devices. As discussed above, one or more of these devices may be configured to stimulate a vestibular system of a user, although the virtual reality device may include haptic devices not configured to stimulate the user's vestibular system.

FIG. 11B shows a non-limiting example of a haptic device 1118. As shown, haptic device 1118 includes an asymmetrical mass attached to a cylindrical motor. Activation of the motor may cause rotation of the asymmetrical mass, which will cause haptic vibrations. The rotational velocity of the mass may be modulated to achieve different haptic frequencies. The pattern of the rotation may be modulated to achieve different haptic intensities.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 12 schematically shows a simplified representation of a computing system 1200 configured to provide any to all of the compute functionality described herein. Computing system 1200 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 1200 includes a logic subsystem 1202 and a storage subsystem 1204. Computing system 1200 may optionally include a display subsystem 1206, input subsystem 1208, communication subsystem 1210, and/or other subsystems not shown in FIG. 12.

Logic subsystem 1202 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 1204 includes one or more physical devices configured to temporarily and/or permanently hold computer information such as data and instructions executable by the logic subsystem. When the storage subsystem includes two or more devices, the devices may be collocated and/or remotely located. Storage subsystem 1204 may include volatile, nonvolatile, dynamic, static, read/write, read-only, random-access, sequential-access, location-addressable, file-addressable, and/or content-addressable devices. Storage subsystem 1204 may include removable and/or built-in devices. When the logic subsystem executes instructions, the state of storage subsystem 1204 may be transformed—e.g., to hold different data.

Aspects of logic subsystem 1202 and storage subsystem 1204 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 1206 may be used to present a visual representation of data held by storage subsystem 1204. This visual representation may take the form of a graphical user interface (GUI). Display subsystem 1206 may include one or more display devices utilizing virtually any type of technology. In some implementations, display subsystem may include one or more virtual-, augmented-, or mixed reality displays, as discussed above.

When included, input subsystem 1208 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 1210 may be configured to communicatively couple computing system 1200 with one or more other computing devices. Communication subsystem 1210 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a virtual reality device comprises: a near-eye display; and a storage machine holding instructions executable by the logic machine to: via the near-eye display, present virtual image frames depicting a virtual environment; dynamically update the virtual image frames to simulate movement of a user of the virtual reality device through the virtual environment; and provide movement-simulating haptics to a vestibular system of the user via one or more vestibular haptic devices, the movement-simulating haptics provided based on the simulated movement of the user through the virtual environment. In this example or any other example, the virtual reality device is a head mounted display device, and the one or more vestibular haptic devices are integrated into a frame of the head mounted display device. In this example or any other example, a vestibular haptic device of the one or more vestibular haptic devices is integrated into a temple support of the head mounted display device and positioned behind an ear of the user. In this example or any other example, a second vestibular haptic device is integrated into a second temple support of the head mounted display device and positioned behind a second ear of the user. In this example or any other example, a vestibular haptic device of the one or more vestibular haptic devices contacts a face of the user. In this example or any other example, the one or more vestibular haptic devices are physically separate from, but communicatively coupled with, the virtual reality device. In this example or any other example, the one or more vestibular haptic devices provide movement-simulating haptics to the vestibular system of the user via bone conduction. In this example or any other example, the movement-simulating haptics provided by the one or more vestibular haptic devices has a vibration frequency and intensity that is inaudible to the user. In this example or any other example, the movement-simulating haptics are provided intermittently as one or more separate pulses. In this example or any other example, the one or more separate pulses are synchronized to simulated footfalls of the user in the virtual environment. In this example or any other example, the one or more separate pulses vary according to one or both of vibration frequency and intensity. In this example or any other example, the movement-simulating haptics are provided continuously. In this example or any other example, the instructions are further executable to provide movement-unrelated haptics to the user regardless of the simulated movement of the user through the virtual environment. In this example or any other example, the movement-unrelated haptics are provided by a haptic device different from the one or more vestibular haptic devices. In this example or any other example, the virtual image frames depicting the virtual environment are rendered by a video game application, and the movement-unrelated haptics are based on a virtual interaction in the video game application. In this example or any other example, the virtual reality device further comprises one or more motion sensors, and the instructions are further executable to reduce the movement-simulating haptics based on detecting, via the one or more motion sensors, that the user is physically moving through a real-world environment.

In an example, a method for reducing motion sickness associated with a virtual reality device comprises: via a near-eye display of the virtual reality device, presenting virtual image frames depicting a virtual environment; dynamically updating the virtual image frames to simulate movement of a user of the virtual reality device through the virtual environment; and providing movement-simulating haptics to a vestibular system of the user via one or more vestibular haptic devices, the movement-simulating haptics provided based on the simulated movement of the user through the virtual environment. In this example or any other example, the virtual reality device is a head mounted display device, and the one or more vestibular haptic devices are integrated into a frame of the head mounted display device. In this example or any other example, the movement-simulating haptics are intermittent and provided as one or more separate pulses, and the one or more separate pulses are synchronized to simulated footfalls of the user in the virtual environment.

In an example, a head mounted display device comprises: one or more temple supports, each of the one or more temple supports including one or more vestibular haptic devices; a near-eye display; a logic machine; and a storage machine holding instructions executable by the logic machine to: via the near-eye display, present virtual image frames depicting a virtual environment; dynamically update the virtual image frames to simulate movement of a user of the head mounted display device through the virtual environment; and provide movement-simulating haptics to a vestibular system of the user via the one or more vestibular haptic devices, the movement-simulating haptics provided based on the simulated movement of the user through the virtual environment.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A virtual reality device, comprising:
a near-eye display;
a logic machine; and
a storage machine holding instructions executable by the logic machine to:
via the near-eye display, present virtual image frames depicting a virtual environment;
dynamically update the virtual image frames to simulate virtual movement of a user of the virtual reality device through the virtual environment, such simulated virtual movement being different from an actual movement of the user through a real-world environment; and
provide movement-simulating haptics to a vestibular system of the user via one or more vestibular haptic devices, the movement-simulating haptics provided based on the simulated movement of the user through the virtual environment.

2. The virtual reality device of claim 1, where the virtual reality device is a head mounted display device, and the one or more vestibular haptic devices are integrated into a frame of the head mounted display device.

3. The virtual reality device of claim 2, where a vestibular haptic device of the one or more vestibular haptic devices is integrated into a temple support of the head mounted display device and positioned behind an ear of the user.

4. The virtual reality device of claim 3, where a second vestibular haptic device is integrated into a second temple support of the head mounted display device and positioned behind a second ear of the user.

5. The virtual reality device of claim 2, where a vestibular haptic device of the one or more vestibular haptic devices contacts a face of the user.

6. The virtual reality device of claim 1, where the one or more vestibular haptic devices are physically separate from, but communicatively coupled with, the virtual reality device.

7. The virtual reality device of claim 1, where the one or more vestibular haptic devices provide movement-simulating haptics to the vestibular system of the user via bone conduction.

8. The virtual reality device of claim 1, where the movement-simulating haptics provided by the one or more vestibular haptic devices has a vibration frequency and intensity that is inaudible to the user.

9. The virtual reality device of claim 1, where the movement-simulating haptics are provided intermittently as one or more separate pulses.

10. The virtual reality device of claim 9, where the one or more separate pulses are synchronized to simulated footfalls of the user in the virtual environment.

11. The virtual reality device of claim 9, where the one or more separate pulses vary according to one or both of vibration frequency and intensity.

12. The virtual reality device of claim 1, where the movement-simulating haptics are provided continuously.

13. The virtual reality device of claim 1, where the instructions are further executable to provide movement-unrelated haptics to the user regardless of the simulated virtual movement of the user through the virtual environment.

14. The virtual reality device of claim 13, where the movement-unrelated haptics are provided by a haptic device different from the one or more vestibular haptic devices.

15. The virtual reality device of claim 13, where the virtual image frames depicting the virtual environment are rendered by a video game application, and the movement-unrelated haptics are based on a virtual interaction in the video game application.

16. The virtual reality device of claim 1, further comprising one or more motion sensors, and where the instructions are further executable to reduce the movement-simulating haptics based on detecting, via the one or more motion sensors, that the user is physically moving through the real-world environment.

17. A method for reducing motion sickness associated with a virtual reality device, the method comprising:
via a near-eye display of the virtual reality device, presenting virtual image frames depicting a virtual environment;
dynamically updating the virtual image frames to simulate virtual movement of a user of the virtual reality device through the virtual environment, such simulated movement being different from an actual movement of the user through a real-world environment; and
providing movement-simulating haptics to a vestibular system of the user via one or more vestibular haptic devices, the movement-simulating haptics provided based on the simulated movement of the user through the virtual environment.

18. The method of claim 17, where the virtual reality device is a head mounted display device, and the one or more vestibular haptic devices are integrated into a frame of the head mounted display device.

19. The method of claim 18, where the movement-simulating haptics are intermittent and provided as one or more separate pulses, and where the one or more separate pulses are synchronized to simulated footfalls of the user in the virtual environment.

20. A head mounted display device, comprising:
one or more temple supports, each of the one or more temple supports including one or more vestibular haptic devices;
a near-eye display;
a logic machine; and
a storage machine holding instructions executable by the logic machine to:
via the near-eye display, present virtual image frames depicting a virtual environment;
dynamically update the virtual image frames to simulate virtual movement of a user of the head mounted display device through the virtual environment, such simulated virtual movement being different from an actual movement of the user through a real-world environment; and
provide movement-simulating haptics to a vestibular system of the user via the one or more vestibular haptic devices, the movement-simulating haptics provided based on the simulated movement of the user through the virtual environment.
